(19) United States
(12) Patent Application Publication
(10) Pub. No.: US 2004/0232769 A1
(43) Pub. Date: Nov. 25, 2004

(54) Motor vehicle electrical load management

(76) Inventor: Stephen Pickering, West Midlands (GB)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/475,390

(22) PCT Filed: Apr. 20, 2001
(86) PCT No.: PCT/GB01/01772

(51) Int. Cl. B60L 3/00

(52) U.S. Cl. 307/10.1

(57) ABSTRACT

The present invention relates to a motor vehicle (1) with an electrical load management system. The electrical load management system comprises: a plurality of electrical consumer units (6-14) including at least one user-activatable consumer unit (6-14) which has a control (31,32) by which said unit may be activated by a user; an electrical source (22) for supplying electrical current (30) to the consumer units (6-14); a monitoring means (2,4,26-28,106-114) for monitoring the ability of the electrical source to deliver electrical current (30) to the consumer units (6-14); an electrical current load controlling means (2,4,106-114) that is responsive to the monitoring means when the ability of the electrical source (22) to deliver electrical current (30) to the consumer units is impaired, in order to limit the electrical current supplied (30) to at least some of the consumer units (6-14) including said user-activatable consumer unit (6-14) according to predetermined criteria by which some consumer units are accorded priority over other consumer units as regards any electrical current limitation. Following activation of the user-activatable consumer unit (6-14), the criteria are temporarily altered to increase temporarily the priority accorded said activated consumer unit (6-14).

The present invention relates to a motor vehicle with an electrical load management system.

The demands placed on typical motor vehicle electrical systems are ever increasing. This is due to the increasing prevalence of features such as electric windows, heated electrical seats, external mirrors and windows, multiple cabin ventilation blowers, and adaptive suspension damping. These consumers of electrical power are, of course, in addition to standard features such as head lamps, turn signal indicators, wind screen wipers, etc. Collectively, all such features, which consume electric power, are referred to herein as “electrical consumer units”.

The increasing demands of electrical consumer units place additional demands on the vehicle electrical system, which comprises the vehicle battery, charging system, and electrical power distribution system including wiring looms throughout the vehicle. A particular model of motor vehicle may be manufactured as one of several model lines, each of which has different, standard electrical consumer units and different optional electrical consumer units. Usually, most vehicles may have some, but not all of the optional electrical consumer units. If all vehicles in a model or model line are provided with a vehicle electrical system specified to meet the maximum possible electrical demand of the most highly specified model line, taking into consideration also adverse environmental conditions, then most vehicles will be burdened with an over capable and expensive vehicle electrical system. In addition to the problem of excess cost, this also imposes a significant weight penalty to such a highly specified vehicle.

One proposed solution to this problem has been disclosed in patent document GB 2 329 082, in which a control unit monitors voltage drop in a sub-region of the motor vehicle wiring system, and then turns off, or modulates on and off, an electrical consumer unit which is tolerant of such voltage drops, such as a heated rear window unit. This permits the gauge of wiring to be reduced, while ensuring that essential electrical consumers for which voltage drops are undesirable, such a rear lights, are not operated at low voltage. This however means that an electrical consumer unit may be inoperative when a driver of the vehicle selects that unit for operation.

It is an object of the present invention to provide a more convenient motor vehicle electrical load management system.

According to the invention, there is provided a motor vehicle with an electrical load management, system comprising:

a) a plurality of electrical consumer units including at least one user-activatable consumer unit which has a control by which said unit may be activated by a user;

b) an electrical source for supplying electrical current to the consumer units;

c) a monitoring means for monitoring the ability of the electrical source to deliver electrical current to the consumer units;

d) an electrical current load controlling means that is responsive to the monitoring means when the ability of the electrical source to deliver electrical current to the consumer units is impaired, in order to limit the electrical current supplied to at least some of the consumer units including said user-activatable consumer unit according to predetermined criteria by which some consumer units are accorded priority over other consumer units as regards any electrical current limitation;

characterised in that

e) the electrical current load controlling means are operative, following activation of the user-activatable consumer unit, to alter said criteria temporarily to increase the priority accorded said activated consumer unit.

The electrical source will normally include one or more batteries, alternators and/or fuel cells, in some cases voltage regulators, and any wiring to the electrical consumer units.

Usually, the electrical source will be at least one battery, although other electrical sources, such as fuel cells, may also be used to provide electrical power to motor vehicle consumer units.

When the electrical load controlling means does limit the electrical current supplied to any of the consumer units, the limit of current to the affected unit may be any of: a cut off of current; a steady reduction in the current; or modulated cut off or reduction in current.

The activated unit may be one that normally has a low priority such as a heated passenger seat. Such a consumer unit according to the predetermined criteria would not be allocated any electric current when the vehicle electrical system is operating at or near capacity. The person activating the consumer unit would then notice that the consumer unit was not operating, and interpret this as a fault with that particular unit of the vehicle's electrical system. According to the invention, however, when a user activates this unit, the electrical load controlling means alters the priority of the activated unit in such a way that this unit is temporarily given increased priority. In this case, the vehicle's electrical system can therefore be designed so that the recently activated consumer unit works at least to some extent during the temporary period in which it is accorded a relatively higher priority.

The criteria may be altered such that the activated unit's priority is increased either in absolute terms, or simply relative to other consumer units' priority. For example, the predetermined criteria may be temporarily altered to decrease temporarily the priority accorded one or more other consumer units.

Following the activation of the user-activatable consumer unit when the ability of the electrical source to deliver electrical current to the consumer units is impaired, the electrical current load controlling means in response to the temporarily altered criteria may cut off or reduce electrical current to said other consumer unit(s).

The electrical consumer unit for which current is limited or cut off may be a user-activatable electrical consumer unit, such as a rear window heater, or an automatic electrical consumer unit, such as an electric motor for an engine fan.

Preferably, the electrical current load controlling means in response to the temporarily altered criteria does not cut off or reduce electrical current to said activated consumer unit when the ability of the electrical source to deliver electrical current to the consumer units is impaired. This may, however, still be necessary in extreme circumstances, for example following the failure of a battery recharging system.

After the temporary change to the criteria, the predetermined criteria are re-established. The activated unit may then be denied electrical current, or made to work on reduced current. The user, however, is much less likely to notice this after it has been clear during the temporary period that the activated unit was operating as expected.

Therefore, the electrical current load controlling means can revert after a delay, which may be predetermined, to limit current to the user-activatable consumer unit according to the predetermined criteria when the ability of the electrical source to deliver electrical current to the consumer units is impaired.

If one or more of the consumer units has an indicator to indicate when a unit is activated, then the indicator preferably continues to indicate to the user that said unit is activated even after the electrical current is limited according to the criteria.

Also according to the invention, there is provided a method of managing electrical load in a motor vehicle, the motor vehicle comprising a plurality of electrical consumer units including at least one user-activatable consumer unit, an electrical source, a monitoring means, an electrical current load controlling means for limiting electrical current to the consumer units, the electrical load controlling means including predetermined criteria by which some consumer units are accorded priority over other consumer units as regards any electrical current limitation, wherein the method comprises the steps of:

i) activating a user-activatable consumer unit;

ii) supplying from the electrical source electrical current to the consumer units;

iii) using the monitoring means to monitor the ability of the electrical source to deliver electrical current to the consumer units;

iv) using the electrical current load controlling means in response to the monitored current delivering ability to limit the electrical current supplied to at least one of the consumer units;

characterised in that the method comprises the step of:

v) following activation of the user-activatable consumer unit, altering said criteria temporarily to increase temporarily the priority accorded said activated consumer unit.

The invention will now be described, by way of example, with reference to the accompanying drawings, in which:

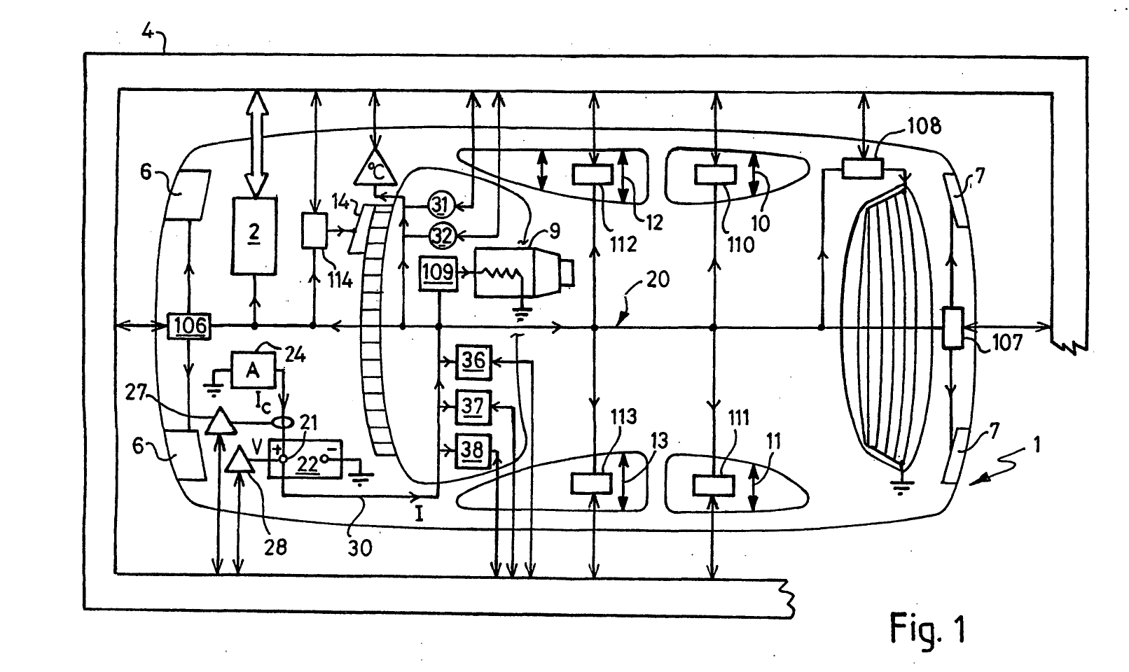

FIG. 1 is a schematic view of a motor vehicle with an electrical load management system according to the invention, that has a number of electrical consumer units;

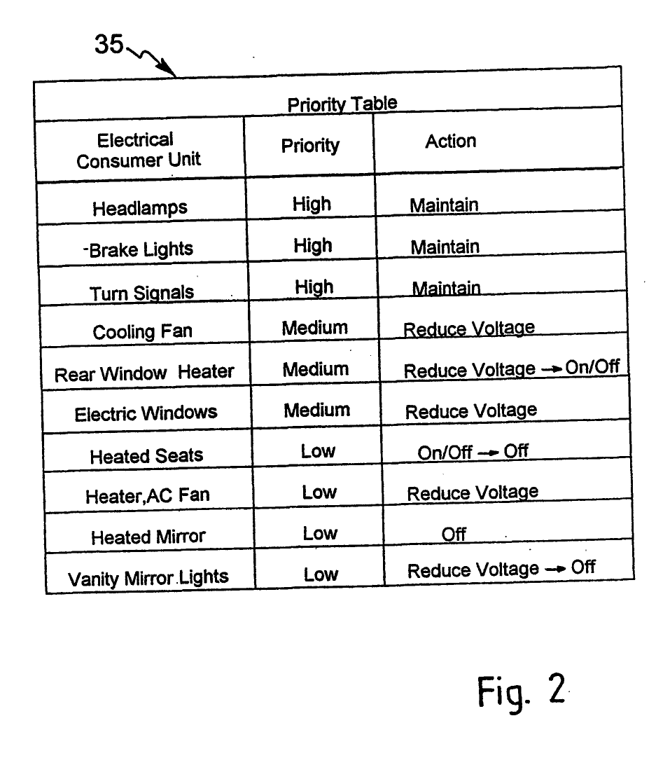

FIG. 2 shows a priority table in which each electrical consumer unit is assigned a priority for its consumption of electrical power; and

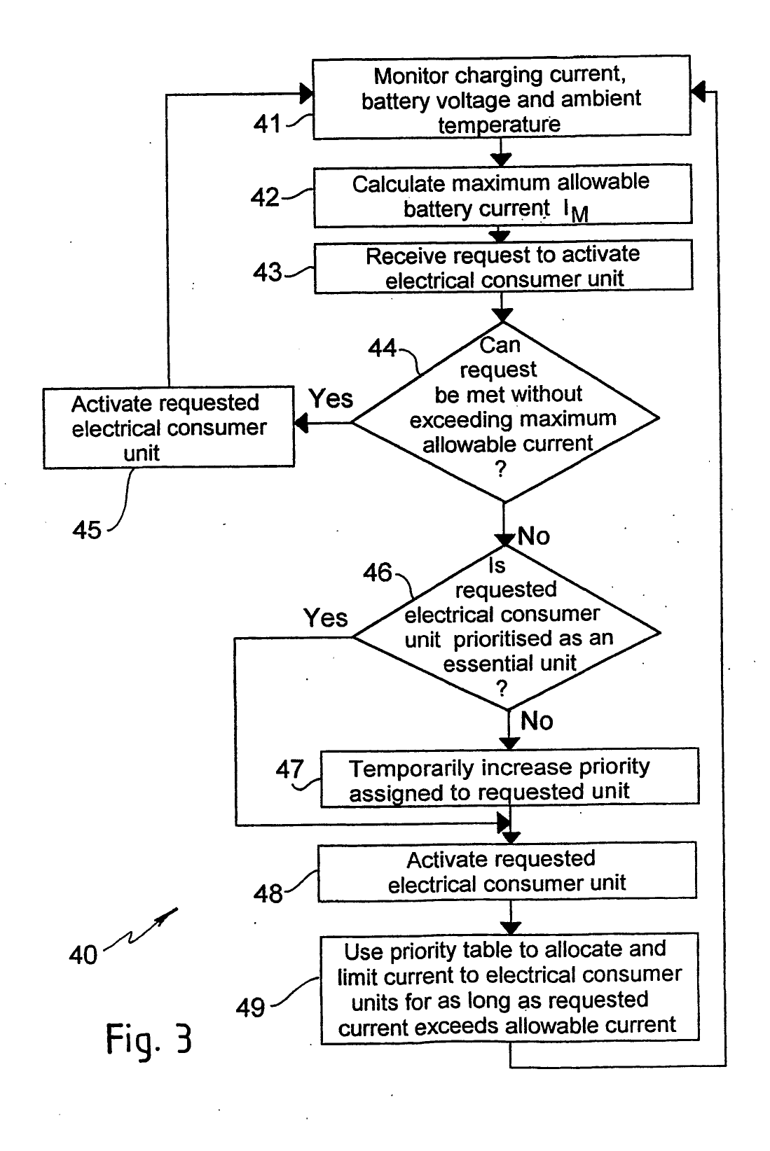

FIG. 3 is a flowchart showing a method of managing electrical load in a motor vehicle.

FIG. 1 shows a schematic view of a motor vehicle 1 with an electrical load management system that comprises a central processor 2 linked to a data transmission means 4 to which are also linked a number of electrical consumer units 6-14 including front head lamps 6, rear tail lights 7, rear heated window 8, heated driver seat 9, four power windows 10-13, and a heater and air conditioning fan 14. The data transmission means 4 may include one or more data busses, such as a CAN bus, and associated processors that link the busses together. For convenience, the data transmission 4 means will be referred to simply as a “bus”.

Each of the electrical consumer units 6-14 has an associated control module 106-114 which receives electrical current from wiring looms shown schematically and indicated generally in the drawing by reference numeral 20 connected to one terminal 21 of a battery 22. The same terminal 21 is also connected to a recharging system including an alternator 24.

Not shown are usual automatic electrical consumer units, such as an engine cooling fan, engine spark-ignition system, air suspension system or active damping system. These, however, would be connected to the bus 4 by means of a control module is a similar manner to the user-activatable electrical consumer units 6-14.

Also connected to the bus 4 are three sensors 26,27,28, which send data to the processor 2 to enable the processor to calculate the maximum allowable battery current (I) 30. These sensors are a temperature sensor 26 for sensing the ambient external temperature, a current sensor 27 for sensing the charge current (I_{c}) delivered by the alternator 24 to the battery 22, and a battery voltage sensor 28 for sensing the output voltage (V) at the battery terminal 21.

For any electrical consumer unit 6-14 to be activated, its associated control unit 106-114 must first receive from the processor 2 via the bus 4 a control signal, which either operates the consumer unit 6-14 at its full or nominal electrical current, or at some limited current. In some circumstances, the control unit 2 may decline to operate an electrical consumer unit 6-14 if the battery 22 is already delivering a current at or near a maximum allowable value.

The motor vehicle 1 includes a number of user-operable controls 31,32, which are also connected via the bus 4 to the processor 2. If a driver or other passenger of the vehicle 1 activates one of these user-operable controls 31,32, then a command is sent to the processor 2, which then sends a further command back on the bus 4 to one of the associated control units 106-114. Some electrical consumer units, whether or not these are user-operable or automatic, may have an associated indicator light 36,37,38 to indicate to a motor vehicle occupant that a particular electrical consumer unit 6-14 is activated.

Referring now also to FIG. 2, which shows a priority table 35, each electrical consumer unit is assigned a priority, for example high, medium or low. Certain electrical consumer units, such as headlamps 6, brake lights 7 or turn signal indicators, must for safety reasons always be operated at a full or nominal current rating. Other electrical consumer units, such as the rear window heater 8, electric windows 10-13, or an engine cooling fan 14, can be operated at less than nominal or full current if there is insufficient current for operation of all electrical consumer units 6-14. For example, an engine cooling fan may be operated at lower speed, particularly if the engine is not significantly overheating. An associated control unit for the engine cooling fan may then reduce the voltage or equivalently the current so that the engine cooling fan operates more slowly. The rear window heater 8 may also be operated at a reduced voltage, in which case the rear window may still be cleared of mist or frost, although at a slower rate. The rear window heater can consume a significant amount of current, and so in severe conditions, it may be permissible to cycle this between on and off states in order to keep the current drawn from the battery 22 within allowable limits. Similarly, electric windows 10-13 may be operated at reduced voltage in which case these windows will still open or close, although more slowly.

Some electrical consumer units can be accorded low priority, either because these have no effect on vehicle safety, or because a driver or passenger will be tolerant if these are operated at a low functionality. Amongst these units are included heated seats 9, heater or air conditioning fans 14, external heated mirrors or internal vanity mirror lights.

The processor 2 includes a memory which stores criteria by which various electrical consumer units 6-14 may be shut down or operated at low full rating in order to conserve electrical current 30. For example, if the external temperature is above about 15° C. then these criteria may show that electric heated windows may be cycled on/off, while if the temperature is below 0°C., these heated windows should not be operated on/off, but at the very least with a reduced steady voltage. These criteria also include the priority listings in the priority table 35, so that if there is only moderate shortfall of available electrical current 30, then only electrical consumer units with a low priority will be affected. If there is a more severe shortage of available electrical current 30, then some medium priority electrical consumer units may additionally be affected.

The invention can now be appreciated more fully with reference also to FIG. 3, which shows a flow chart 40 describing operation of the electrical load management system. The control unit 2 monitors 41 a charging current (I_{c}), battery voltage (V) and ambient temperature (T). From this, the processor 2 can calculate 42 a maximum allowable battery current (I_{M}). If a vehicle occupant operates one of the controls 31,32 to activate a user-operable electrical consumer unit 6-14, then the processor 2 first then receives 43 this request via the bus 4. Since all significant electrical consumer units are controlled via the processor 2, the processor can calculate the total current drawn by these units at a particular battery voltage V and external temperature T. The processor 2 calculates the total expected current including the most recently requested user-operable electrical consumer unit, and then decides 44 whether or not the request can be met without exceeding the maximum allowable current I_{M}.

If the request can be met without exceeding the maximum allowance current I_{M}, then the processor 2 sends a signal to activate 45 the requested electrical consumer unit 6-14, without imposing any limitation on the current drawn by any of the consumer units. If, on the other hand, the total expected current does exceed the maximum allowable current I_{M} then the processor 2 checks 46 if the requested electrical consumer unit 6-14 is one of those with a high priority, for which it is essential that the unit is supplied with full or nominal electric current. If the electrical consumer unit is an essential unit, then the processor 2 sends a command to activate 48 this unit. If, on the other hand, the requested electrical unit is one with a lower priority, then the processor 2 temporarily increases 47 the priority assigned to this requested unit. The result is that when an electrical consumer unit is first requested, even if this unit does not have high priority, it will, at least during the temporary period during which its priority is increased, be active. Therefore, a user of the electrical consumer unit will not perceive that this unit is inoperative or operating below its nominal capacity.

As a consequence, it may be necessary to limit the current to other electrical consumer units. Therefore, the processor 2 uses 49 the priority table 35 to allocate and limit current to electrical consumer units according to the various criteria for these units, for as long as the requested current exceeds the allowable maximum current I_{M}.

The processor 2 then continues to monitor 41 the charging current I_{c}, drawn current I, battery voltage V and ambient temperature T, as described above.

If it is necessary to limit the current supply to any electrical consumer unit 6-14, then any indicator lights 36-38 or other type of indicator, will continue to show that an electrical consumer unit is activated, even when an electrical current to such a unit is limited. Therefore, a user of the electrical consumer units, and particularly of user-operable consumer units, will continue to see that units have been selected for activation, even when it is necessary in some way to limit the total current drawn by these units. If the total requested current drops below the maximum available current, then full functionality is restored to any affected electrical consumer units.

The invention therefore provides a convenient way of limiting and controlling the distribution of electrical power in a motor vehicle, in such a way that a user of the vehicle, particularly the driver, does not perceive that a unit which he has recently selected for operation is inoperable.

1. A motor vehicle (1) with an electrical load management system comprising:
a) a plurality of electrical consumer units (6-14) including at least one user-activatable consumer unit (6-14) which has a control (31,32) by which said unit may be activated by a user;
b) an electrical source (22) for supplying electrical current to the consumer units (6-14);
c) a monitoring means (2,4,26-28,10-114) for monitoring the ability of the electrical source to deliver electrical current (I) to the consumer units;
d) an electrical current load controlling means (2,4,106-114) that is responsive to the monitoring means when the ability of the electrical source (22) to deliver electrical current to the consumer units is impaired, in order to limit the electrical current supplied to at least some of the consumer units including said user-activatable consumer unit according to predetermined criteria by which some consumer units are accorded priority over other consumer units as regards any electrical current limitation;
characterised in that
e) the electrical current load controlling means are operative, following activation of the user-activatable consumer unit, to alter said criteria temporarily to increase the priority accorded said activated consumer unit (6-14).

2. A motor vehicle as claimed in claim 1, in which following activation of the user-activatable consumer unit, the predetermined criteria are temporarily altered to decrease temporarily the priority accorded one or more other consumer units.

3. A motor vehicle with an electrical load management system as claimed in claim 2, in which following said activation of the user-activatable consumer unit, the electrical current load controlling means in response to the temporarily altered criteria cuts off or limits electrical current to said other consumer unit(s) when the ability of the electrical source to deliver electrical current to the consumer units is impaired.

4. A motor vehicle as claimed in any preceding claim, in which the electrical current load controlling means in response to the temporarily altered criteria does not cut off electrical current to said activated consumer unit when the ability of the electrical source to deliver electrical current to the consumer units is impaired.

5. A motor vehicle with an electrical load management system as claimed in claim 4, in which following activation of the user-activatable consumer unit, the electrical current load controlling means in response to the temporarily altered criteria does not reduce electrical current to said activated consumer unit when the ability of the electrical source to deliver electrical current to the consumer units is impaired.

6. A motor vehicle with an electrical load management system as claimed in any preceding claim, in which following activation of the user-activatable consumer unit, the electrical current load controlling means in response to the temporarily altered criteria reverts after a delay to limit current to the user-activatable consumer unit in response to the predetermined criteria when the ability of the electrical source to deliver electrical current to the consumer units is impaired.

7. A motor vehicle with an electrical load management system as claimed in claim 6, in which said delay is predetermined.

8. A motor vehicle with an electrical load management system as claimed in any preceding claim, in which one or more consumer units have an indicator to indicate when a unit is activated, the indicator continuing to indicate to the user that said unit is activated even after the electrical current is limited according to the criteria.

9. A method of managing electrical load in a motor vehicle, the motor vehicle comprising a plurality of electrical consumer units including at least one user-activatable consumer unit, an electrical source, a monitoring means, an electrical current load controlling means for limiting electrical current to the consumer units, the electrical load controlling means including predetermined criteria by which some consumer units are 3ccorded priority over other consumer units as regards any electrical current limitation, wherein the method comprises the steps of:
i) activating a user-activatable consumer unit;
ii) supplying from the electrical source electrical current to the consumer units;
iii) using the monitoring means to monitor the ability of :he electrical source to deliver electrical current to the consumer units;
iv) using the electrical current load controlling means in response to the monitored current delivering ability to limit the electrical current supplied to at least one of the consumer units;
characterised in that the method comprises the step of:
v) following activation of the user-activatable consumer unit, altering said criteria temporarily to increase temporarily the priority accorded said activated consumer unit.
